(19) United States
(12) Patent Application Publication
(10) Pub. No.: US 2024/0267855 A1
(43) Pub. Date: Aug. 8, 2024

(54) COMMUNICATION METHOD AND APPARATUS

(71) Applicant: HUAWEI TECHNOLOGIES CO., LTD., Shenzhen (CN)

(72) Inventors: Shitong YUAN, Chengdu (CN); Fengwei LIU, Chengdu (CN); Xinghua SONG, Beijing (CN)

(21) Appl. No.: 18/618,497

(22) Filed: Mar. 27, 2024

Related U.S. Application Data
(63) Continuation of application No. PCT/CN2022/122237, filed on Sep. 28, 2022.

(30) Foreign Application Priority Data
Sep. 30, 2021 (CN) 202111165893.1

(51) Int. Cl. H04W 52/36; H04L 5/00; H04W 24/10; H04W 76/20

(52) U.S. Cl. CPC H04W 52/367; H04L 5/0051; H04W 24/10; H04W 76/20

(57) ABSTRACT

A communication method and an apparatus. A first node receives a first message from a second node. The first message indicates a first ratio corresponding to a first downlink reference signal. The first ratio is a power ratio that is between data and a downlink reference signal and is obtained after downlink transmission power adjustment is performed by a parent node. The first node sends a second message to the parent node. The second message includes a first measurement result. The first measurement result is determined based on the first ratio, and the first measurement result is determined based on the first downlink reference signal.

### CROSS-REFERENCE TO RELATED APPLICATIONS

This application is a continuation of International Application No. PCT/CN2022/122237, filed on Sep. 28, 2022, which claims priority to Chinese Patent Application No. 202111165893.1, filed on Sep. 30, 2021. The disclosures of the aforementioned applications are hereby incorporated by reference in their entireties.

### BACKGROUND

With continuous development of mobile communication technologies, spectrum resources become increasingly insufficient. To improve spectrum utilization, base stations will be deployed more densely in the future. In addition, dense deployment further avoids coverage holes. In a conventional cellular network architecture, a base station establishes a connection to a core network through an optical fiber. However, deployment costs of optical fibers are very high in many scenarios. A wireless relay node (RN) establishes a connection to the core network through a wireless backhaul link, to reduce a part of optical fiber deployment costs.

Usually, a relay node establishes a wireless backhaul link to one or more parent nodes, and accesses the core network through the parent node. In addition, the relay node provides a service for a plurality of child nodes. A link for communicating with the parent node is usually referred to as a backhaul link, and a link for communicating with the child node or UE is usually referred to as an access link. Resource multiplexing is performed on the access link and the backhaul link in time division, space division, or frequency division mode.

In a space division multiplexing scenario, the backhaul link and the access link operates at a same moment, and the relay node simultaneously receives a downlink signal sent by the parent node on the backhaul link and an uplink signal sent by the child node on the access link, to improve spectrum efficiency. Certainly, the relay node sends signals simultaneously.

In a space division receiving scenario, how to improve communication quality is a technical problem that is to be resolved.

### SUMMARY

Embodiments described herein provide a communication method and apparatus, to improve communication quality.

According to a first aspect, a communication method is provided. The method is performed by a first node, or by a component used in the first node, for example, a chip or a processor. The following uses an example in which the method is performed by the first node for description. First, a first node receives a first message from a second node. The first message indicates a first ratio corresponding to a first downlink reference signal. The first ratio is a power ratio that is between data and a downlink reference signal and that is obtained after downlink transmission power adjustment is performed by a parent node. Then, the first node sends a second message to the parent node. The second message includes a first measurement result, the first measurement result is determined based on the first ratio, and the first measurement result is determined based on the first downlink reference signal.

In at least one embodiment, the power ratio that is between the data and the downlink reference signal and that is obtained after the downlink transmission power adjustment (or that is measured in a space division mode) is configured for the first node, so that the first node reports, to a parent node, a measurement result obtained based on the power ratio that is between the data and the downlink reference signal and that is obtained after the downlink transmission power adjustment (or that is measured in the space division mode). In this case, the parent node obtains a measurement result (for example, a CQI measurement result) during measurement in the space division mode, so that the parent node determines a transmission parameter for downlink transmission scheduling in a space division slot (after a downlink transmission power is adjusted), and communication performance is improved.

The second node is the same as or different from the parent node. In response to the second node being different from the parent node, optionally, the second node is a parent node of the parent node that receives the second message.

In at least one embodiment, in response to the second node being the parent node, the first message further indicates the downlink transmission power adjustment amount used by the parent node and a corresponding first beam. An existing downlink power control response message carries information about the first ratio. An existing message (which is, for example, referred to as a power control response message) is used as the first message, so that signaling exchange is reduced. Certainly, the first message is a message other than the power control response message, for example, information for configuring a downlink resource.

In at least one embodiment, in response to the second node being a donor node, the first message includes downlink reference signal resource configuration information. Existing downlink reference signal resource configuration information carries the information about the first ratio. The existing message is used as the first message, so that the signaling exchange is reduced.

In at least one embodiment, the first node first receives a third message from the parent node. The third message indicates a downlink transmission power adjustment amount used by the parent node and a corresponding first beam. Then, the second message is sent to the parent node.

In at least one embodiment, the second message further includes a second measurement result. The second measurement result is determined based on a second ratio, and the second measurement result is determined based on the first downlink reference signal. The second ratio is a power ratio that is between data and a downlink reference signal and that is used before downlink transmission power adjustment is not performed by the parent node. The first node reports, to the parent node, a measurement result obtained based on the power ratio that is between the data and the downlink reference signal and that is used before the downlink transmission power adjustment (or that is measured in a time division mode) is not performed. In this case, the parent node obtains a measurement result (for example, a CQI measurement result) during measurement in the time division mode, so that the parent node determines a transmission parameter for downlink transmission scheduling in a time division slot (after the downlink transmission power is adjusted), and communication performance is improved.

In at least one embodiment, in response to a beam for measuring the first downlink reference signal being a beam associated with the first beam, a determination is made to report the first measurement result corresponding to the beam for measuring the first downlink reference signal, or a determination is made to report the first measurement result and the second measurement result corresponding to the beam for measuring the first downlink reference signal. In response to a beam for measuring a downlink reference signal not being a beam associated with the first beam, a determination is made to report the second measurement result corresponding to the beam for measuring the downlink reference signal. The first beam is a beam on which the parent node allows to perform downlink transmission power adjustment.

In at least one embodiment, the first node sends a fourth message to the parent node. The fourth message indicates a downlink transmission power adjustment amount desired by the first node and a second beam corresponding to the desired downlink transmission power adjustment amount. Then, the first node receives the first message from the second node.

According to a second aspect, a communication method is provided. The method is performed by a second node, or by a component used in the second node, for example, a chip or a processor. The following uses an example in which the method is performed by the second node for description. First, a second node sends a first message to a first node. The first message indicates a first ratio corresponding to a first downlink reference signal. The first ratio is a power ratio that is between data and a downlink reference signal and that is obtained after downlink transmission power adjustment is performed by the second node. The second node receives a second message from the first node. The second message includes a first measurement result. The first measurement result is determined based on the first ratio, and the first measurement result is determined based on the first downlink reference signal.

In at least one embodiment, the second node configures the power ratio that is between the data and the downlink reference signal and that is obtained after the downlink transmission power adjustment (or that is measured in a space division mode) for the first node, so that the first node reports, to the second node, a measurement result obtained based on the power ratio that is between the data and the downlink reference signal and that is obtained after the downlink transmission power adjustment (or that is measured in the space division mode). In this case, the second node obtains a measurement result (for example, a CQI measurement result) during measurement in the space division mode, so that the second node determines a transmission parameter for downlink transmission scheduling in a space division slot (after a downlink transmission power is adjusted), and communication performance is improved.

In at least one embodiment, in response to the second node being a parent node, the first message further indicates a downlink transmission power adjustment amount used by the second node and a corresponding first beam. An existing downlink power control response message carries information about the first ratio. An existing message is used as the first message, so that signaling exchange is reduced.

In at least one embodiment, in response to the second node being a donor node, the first message includes downlink reference signal resource configuration information. Existing downlink reference signal resource configuration information carries the information about the first ratio. The existing message is used as the first message, so that the signaling exchange is reduced.

In at least one embodiment, the second node first sends a third message to the first node. The third message indicates the downlink transmission power adjustment amount used by the second node and a corresponding first beam. Then, the second message from the first node is received.

In at least one embodiment, the second message further includes a second measurement result. The second measurement result is determined based on a second ratio, and the second measurement result is determined based on the first downlink reference signal. The second ratio is a power ratio that is between data and a downlink reference signal and that is used before downlink transmission power adjustment is not performed by the second node. The first node reports, to the second node, a measurement result obtained based on the power ratio that is between the data and the downlink reference signal and that is used before the downlink transmission power adjustment (or that is measured in a time division mode) is not performed. In this case, the second node obtains a measurement result (for example, a CQI measurement result) during measurement in the time division mode, so that the second node determines a transmission parameter for downlink transmission scheduling in a time division slot (after the downlink transmission power is adjusted), and communication performance is improved.

In at least one embodiment, the second node first receives a fourth message from the first node. The fourth message indicates a downlink transmission power adjustment amount desired by the first node and a second beam corresponding to the desired downlink transmission power adjustment amount. Then, the first message is sent to the first node.

According to a third aspect, a communication apparatus is provided. The apparatus has a function of implementing any one of the first aspect, or a function of implementing any one of the second aspect. The function is implemented by hardware, or is implemented by hardware by executing corresponding software. The hardware or software includes one or more functional modules corresponding to the foregoing function.

According to a fourth aspect, a communication apparatus is provided. The communication apparatus includes a processor. Optionally, the communication apparatus further includes a memory. The processor is coupled to the memory. The memory is configured to store a computer program or instructions. The processor is configured to execute a part or all of the computer program or the instructions in the memory. In response to the part or all of the computer program or the instructions being executed, the processor is configured to implement a function of the first node in the method in any one of the first aspect, or implement a function of the second node in any one of the second aspect.

In at least one embodiment, the apparatus further includes a transceiver, and the transceiver is configured to transmit a signal processed by the processor, or receive a signal input into the processor. The transceiver performs a transmit action or a receiving action performed by the first node in any one of the first aspect and, or perform a transmitting action or a receiving action performed by the second node in any one of the second aspect.

According to a fifth aspect, at least one embodiment provides a chip system. The chip system includes one or more processors (which is also referred to as processing circuits). The processor is electrically coupled to a memory (which is also referred to as a storage medium). The memory is located in the chip system, or is not located in the chip system. The memory is configured to store a computer program or instructions. The processor is configured to execute a part or all of the computer program or the instructions in the memory. In response to the part or all of the computer program or the instructions being executed, the processor is configured to implement a function of the first node in the method in any one of the first aspect, or implement a function of the second node in any one of the second aspect.

In at least one embodiment, the chip system further includes an input/output interface (which is also referred to as a communication interface). The input/output interface is configured to output a signal processed by the processor, or receive a signal input to the processor. The input/output interface performs a transmitting action or a receiving action performed by the first node in any one of the first aspect, or perform a transmitting action or a receiving action performed by the second node in any one of the second aspect. Specifically, the output interface performs a transmitting action, and the input interface performs a receiving action.

In at least one embodiment, the chip system includes a chip, or includes the chip and another discrete device.

According to a sixth aspect, a computer-readable storage medium is provided, configured to store a computer program. The computer program includes instructions for implementing the function in any one of the first aspect, or instructions for implementing the function in any one of the second aspect.

Alternatively, a computer-readable storage medium is configured to store a computer program. In response to the computer program being executed by a computer, the computer is enabled to perform the method performed by the first node in any one of the first aspect, or perform the method performed by the second node in any one of the second aspect.

According to a seventh aspect, a computer program product is provided. The computer program product includes computer program code. In response to the computer program code being run on a computer, the computer is enabled to perform the method performed by the first node in any one of the first aspect, or perform the method performed by the second node in any one of the second aspect.

According to an eighth aspect, a communication system is provided. The communication system includes the first node for performing the method in any one of the first aspect and the second node for performing the method in any one of the second aspect.

For technical effects in the third aspect to the eighth aspect, refer to the descriptions in the first aspect and the second aspect. Details are not repeated herein.

### BRIEF DESCRIPTION OF DRAWINGS

FIG. 1 is a schematic diagram of an architecture of a communication system according to at least one embodiment:

FIG. 2a is a schematic diagram of an architecture of a communication system according to at least one embodiment:

FIG. 2b is an internal schematic diagram of a relay node according to at least one embodiment:

FIG. 3 is a schematic diagram of a space division receiving scenario according to at least one embodiment:

FIG. 4 is a flowchart of a communication method according to at least one embodiment:

FIG. 5 is a flowchart of a communication method according to at least one embodiment:

FIG. 6 is a flowchart of a communication method according to at least one embodiment:

FIG. 7 is a flowchart of a communication method according to at least one embodiment:

FIG. 8 is a schematic diagram of arrival time according to at least one embodiment:

FIG. 9 is a diagram of a structure of a communication apparatus according to at least one embodiment; and

FIG. 10 is a diagram of a structure of a communication apparatus according to at least one embodiment.

### DESCRIPTION OF EMBODIMENTS

For ease of understanding embodiments described herein, the following describes a part of terms in at least one embodiment, to help a person skilled in the art have a better understanding.

### 1. Beam:

The beam is a communication resource. The beam is a wide beam, a narrow beam, or another type of beam. A technology for forming the beam is a beam forming technology or another technical means. The beam forming technology is a digital beam forming technology, an analog beam forming technology, or a hybrid digital/analog beam forming technology. Different beams are considered as different resources. Same information or different information is sent by different beams.

Optionally, a plurality of beams having same or similar communication features is considered as one beam. One beam corresponds to one or more antenna ports, and is for transmitting a data channel, a control channel, a sounding signal, and the like. For example, a transmit beam refers to signal strength distribution formed in different directions in space after a signal is transmitted through an antenna, and a receive beam refers to signal strength distribution in different directions in space of a radio signal received from an antenna. One or more antenna ports forming one beam is also considered as one antenna port set.

In response to a low frequency band or an intermediate frequency band being used, signals are sent in an omnidirectional manner or sent at a wide angle. However, in response to a high frequency band being used, because of a small carrier wavelength of a high frequency communication system, antenna arrays including a plurality of antenna elements is disposed at a transmit end and a receive end, and the transmit end sends a signal based on a specific beam forming weight, so that the sent signal forms a beam having spatial directivity. In addition, the receive end receives the signal through the antenna array based on a specific beam forming weight, so that a receive power of the signal at the receive end is increased, and a path loss is avoided.

### 2. Quasi Co-Location (QCL):

The QCL indicates that a plurality of resources have one or more same or similar communication features. For a plurality of resources having a QCL relationship, a same or similar communication configuration is used. For example, in response to two antenna ports having a QCL relationship, a channel large-scale characteristic of transmitting one symbol by one port is inferred from a channel large-scale characteristic of transmitting one symbol by the other port. The large-scale characteristic includes delay spread, an average delay, Doppler spread, Doppler frequency shift, an average gain, a receive parameter, a receive beam number of a terminal device, transmit/receive channel correlation, an angle of arrival, spatial correlation of a receiver antenna, a dominant angle of arrival (AoA), an average angle of arrival, AoA spread, and the like.

During application, a co-location indication indicates whether at least two groups of antenna ports have a QCL relationship. That the co-location indication indicates whether the at least two groups of antenna ports have the QCL relationship is understood as that the co-location indication indicates whether channel state information-reference signals (CSI-RSs) sent by the at least two groups of antenna ports are from a same transmission point, or the co-location indication indicates whether channel state information-reference signals (CSI-RSs) sent by the at least two groups of antenna ports are from a same beam group.

### 3. Transmission Configuration Indicator (TCI):

The TCI is a field that is in downlink control information (DCI) and that indicates a QCL relationship between antenna ports of a physical downlink shared channel (PDSCH).

The TCI is configured by a higher layer, such as a radio resource control (RRC) layer. In configuration signaling, the TCI is referred to as a TCI state, and the TCI state is an information structure, including beam-related information. After the TCI is configured by the RRC layer, a media access control (MAC) control element (CE) (MAC-CE) is sent by a base station to activate one or more TCI states. The base station further sends downlink control information (DCI) to indicate one of a plurality of activated TCI states.

A higher layer in a protocol configures a QCL by using the TCI state. A parameter of the TCI state is for configuring a QCL relationship between one or two downlink reference signals and a demodulation reference signal (DMRS) of the PDSCH. The TCI includes one or two QCL relationships. The QCL represents a consistency relationship between a signal/channel that is currently to be received (or sent) by a terminal device and a previously known reference signal. Therefore, in response to there being a QCL relationship, the terminal device inherits a parameter of a previously received (or sent) reference signal, to receive (or send) a to-be-received signal/channel.

During application, in response to the TCI state including information with an identifier of QCL Type-D, the TCI state indicates a beam. In response to the TCI state including information with an identifier of QCL Type-A, QCL Type-B, or QCL Type-C, the TCI state indicates information (excluding space domain information) such as a time domain offset and a frequency domain offset, and is generally for assisting the terminal device in data receiving and demodulation. During implementation, in response to two TCI state configurations using a same source reference signal of the QCL Type-D, the two TCI states have a QCL relationship, or a same beam is used.

4. Reference signal (RS): According to a long term evolution LTE/NR protocol, at a physical layer, uplink communication includes transmission of an uplink physical channel and an uplink signal. The uplink physical channel includes a random access channel (PRACH), an uplink control channel (physical uplink control channel, PUCCH), an uplink data channel (PUSCH), and the like. The uplink signal includes a channel sounding reference signal SRS, a physical uplink control channel demodulation reference signal (PUCCH-DMRS), a physical uplink shared channel demodulation reference signal PUSCH-DMRS, an uplink phase tracking reference signal (PTRS), an uplink positioning reference signal (uplink positioning RS), and the like. Downlink communication includes transmission of a physical downlink channel and a downlink signal. The downlink physical channel includes a broadcast channel (PBCH), a downlink control channel (PDCCH), a downlink data channel (PDSCH), and the like. The downlink signal includes a primary synchronization signal (PSS)/secondary synchronization signal (SSS), a physical downlink control channel demodulation reference signal PDCCH-DMRS, a physical downlink shared channel demodulation reference signal PDSCH-DMRS, a phase tracking reference signal PTRS, a channel state information reference signal (CSI-RS), a cell signal (CRS) (not available in NR), a fine synchronization signal (time/frequency tracking reference signal, TRS) (not available in LTE), LTE/NR positioning reference signal (positioning RS), and the like.

### 5. Transmission Timing:

Case 1, Case 6, and Case 7 are names discussed in a standard conference.

Case 1 timing: Timing used in response to an IAB-MT and DU being in a time division multiplexing mode, and in this case, a timing scheme of the MT is essentially the same as that of common UE.

Downlink timing: Downlink transmission timing of an IAB node and downlink transmission timing of an IAB donor node are aligned.

Uplink timing: Uplink transmission timing of the IAB node, which is the same as that of another UE, obtains the uplink timing in a manner specified in a protocol, for example, controls signaling based on TA sent by a base station.

Case 7 timing: A timing solution used by an IAB to perform space division reception.

Downlink timing: Downlink transmission timing of an IAB node and downlink transmission timing of an IAB donor node are aligned.

Uplink timing (receiving or sending): UL receiving timing of an IAB node DU is aligned with DL receiving timing of the IAB node. Correspondingly, to cooperate with a parent node in simultaneous reception, a child node of the IAB node is to perform offset based on uplink sending timing in Case 1.

In FIG. 3, an IAB node #1 receives an uplink signal transmitted by a child node IAB node #2 in response to the IAB node #1 receiving a downlink signal transmitted by a donor. In this case, simultaneous reception in SDM spatial multiplexing transmission is enabled.

During implementation, an MT of an IAB node obtains an offset value offset of uplink sending time. In response to the MT performing multiplexing transmission, or a parent node performing an explicit indication, the IAB node MT determines the uplink sending time based on current uplink timing advance TA and the offset, for example, by adding the TA and the offset. Alternatively, the donor or the parent node preconfigures some time resources, for example, a slot set. The IAB node MT determines, on the time resources, the uplink sending time based on current uplink timing advance TA and the offset.

Case 6 timing: A timing solution used by an IAB to perform space division sending.

Downlink timing: Downlink transmission timing of an IAB node and downlink transmission timing of an IAB donor node are aligned.

Uplink timing (sending): UL sending timing of the IAB node is aligned with DL sending timing of the IAB node.

6. A network device is a device that provides a random access function for a terminal device or a chip that is disposed in the device. The device includes but is not limited to an evolved NodeB (eNB), a radio network controller (RNC), a NodeB (NB), a base station controller (BSC), a base transceiver station (BTS), a home base station (for example, home evolved NodeB or home NodeB, HNB), a baseband unit (BBU), an access point (AP) in a wireless fidelity (Wi-Fi) system, a wireless relay node, a wireless backhaul node, a transmission point (transmission and reception point, TRP, or transmission point, TP), or the like, is a gNB or a transmission point (TRP or TP) in a 5G system such as an NR system or one or one group of antenna panels (including a plurality of antenna panels) of a base station in a 5G system, or is a network node forming a gNB or a transmission point, for example, a baseband unit (BBU) or a distributed unit (DU).

7. A terminal device, which is also referred to as user equipment (UE), a mobile station (MS), a mobile terminal (MT), a terminal, or the like, is a device that provides voice and/or data connectivity for a user. For example, the terminal device is a handheld device, a vehicle-mounted device, or the like that has a wireless connection function. Currently, the terminal device is a mobile phone, a tablet computer, a laptop computer, a palmtop computer, a mobile internet device (MID), a wearable device, a virtual reality (VR) device, an augmented reality (AR) device, a wireless terminal in industrial control, a wireless terminal in self driving, a wireless terminal in remote surgery, a wireless terminal in a smart grid, a wireless terminal in transportation safety, a wireless terminal in a smart city, a wireless terminal in a smart home, a wireless terminal in vehicle-to-vehicle (V2V) communication, or the like.

8. A relay device is an entity that receives information from a terminal device, a network device, or another relay device, and forward the information to another terminal, another network device, or another relay device. A name of the relay device is a relay node (RN), and a form of the relay device is a small cell, an integrated access and backhaul (IAB) node, a distributed unit (DU), a terminal device, a transmission and reception point (TRP), a relay transmission reception point (rTRP), an IAB node, or the like. In NR, the relay node is generally referred to as an IAB node.

9. A term “and/or” in at least one embodiment describes an association relationship between associated objects and represents that three relationships exist. For example, A and/or B represents the following three cases: Only A exists, both A and B exist, and only B exists. A character “/” generally indicates an “or” relationship between the associated objects. “A plurality of” in at least one embodiment means two or more than two. In addition, in description of at least one embodiment, terms such as “first” and “second” are merely for distinguishing and description, but should not be understood as indicating or implying relative importance, or should not be understood as indicating or implying a sequence.

To facilitate understanding of technical solutions in at least one embodiment, the following briefly describes a system architecture of a method provided in at least one embodiment. The system architecture described in at least one embodiment is intended to describe the technical solutions in at least one embodiment more clearly, and does not constitute any limitation on the technical solutions provided in at least one embodiment.

The technical solutions in at least one embodiment are applied to various communication systems, for example, a satellite communication system and a conventional mobile communication system. The satellite communication system is integrated with the conventional mobile communication system (to be specific, a terrestrial communication system). For example, the communication system is a wireless local area network (WLAN) communication system, a wireless fidelity (Wi-Fi) system, a long term evolution (LTE) system, an LTE frequency division duplex (FDD) system, an LTE time division duplex (TDD) system, a 5th generation (5G) system or a new radio (NR) system, a 6th generation (6G) system, or another future communication system. The communication system further supports a communication system integrating a plurality of wireless technologies, for example, is also used in a system that integrates a non-terrestrial network (NTN) and a ground mobile communication network, such as an unmanned aerial vehicle, a satellite communication system, and high altitude platform station (HAPS) communication.

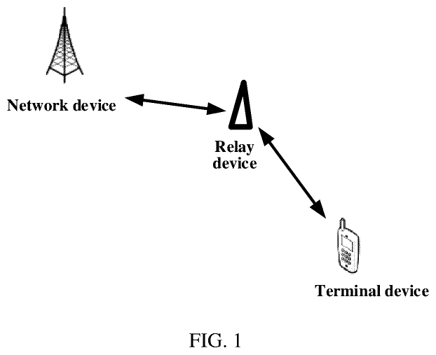

Embodiments described herein are applicable to a wireless communication system including a relay device. FIG. 1 shows an example of a communication system applicable to at least one embodiment. The communication system includes a network device, a relay device, and a terminal device. For downlink transmission, the relay device receives data sent by the network device, and forwards the data to the terminal device. For uplink transmission, the relay device receives data sent by the terminal device, and forwards the data to the network device.

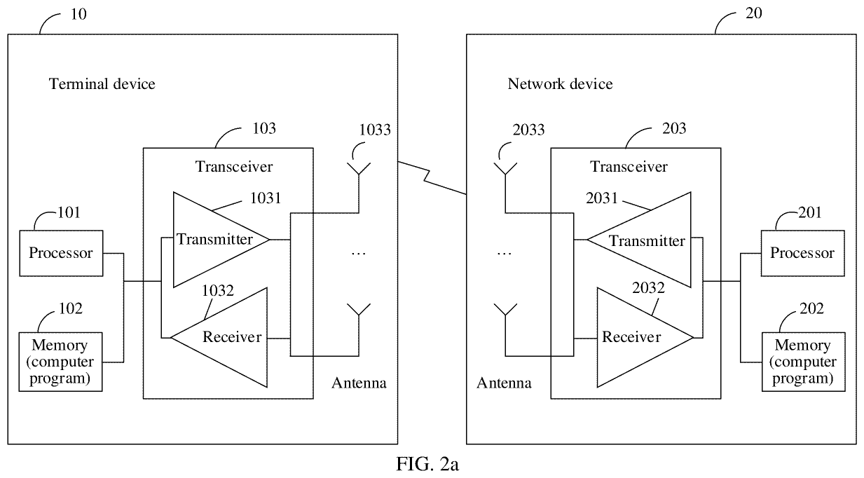

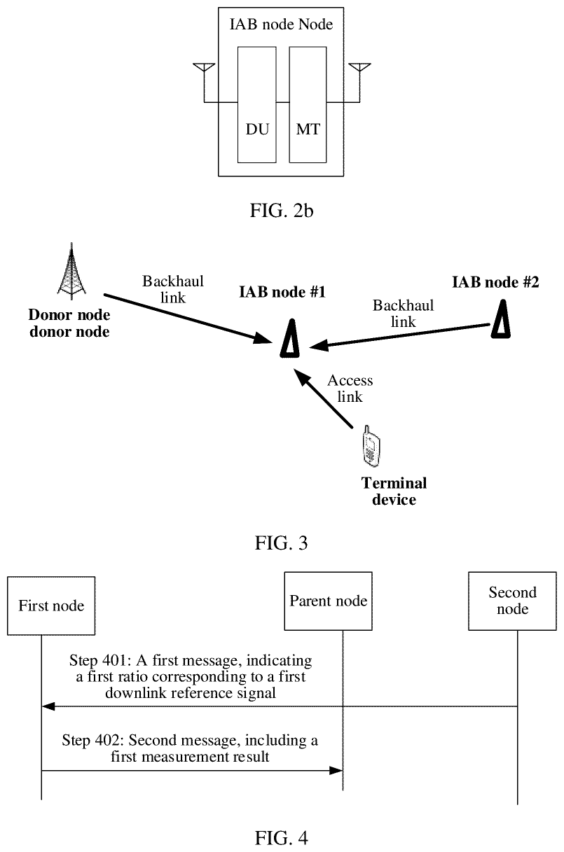

Communication between each network device and each terminal device in the communication system is alternatively represented in another form. As shown in FIG. 2a, a terminal device 10 includes at least one processor 101 and at least one transceiver 103. Optionally, the terminal device 10 further includes at least one memory 102. The memory 102 exists independently, or the memory 102 is integrated with the processor 101, for example, integrated into a chip. The memory 102 stores program code for performing the technical solutions in at least one embodiment, and the processor 101 controls execution of the program code. Various types of computer program code to be executed are also considered as drivers of the processor 101. For example, the processor 101 is configured to execute the computer program code stored in the memory 102, to implement the technical solutions in at least one embodiment. The transceiver 103 includes a transmitter 1031, a receiver 1032, and an antenna 1033. The receiver 1032 is configured to receive data or control signaling from a network device 20 by using the antenna 1033, and the transmitter 1031 is configured to send information to the network device 20 by using the antenna 1033.

The network device 20 includes at least one processor 201 and at least one transceiver 203. Optionally, the network device 20 further includes at least one memory 202. The memory 202 exists independently, or the memory 202 is integrated with the processor 201, for example, integrated into a chip. The memory 202 stores program code for performing the technical solutions in at least one embodiment, and the processor 201 controls execution of the program code. Various types of computer program code to be executed are also considered as drivers of the processor 201. For example, the processor 201 is configured to execute the computer program code stored in the memory 202, to implement the technical solutions in at least one embodiment. The transceiver 203 includes a transmitter 2031, a receiver 2032, and an antenna 2033. The transmitter 2031 is configured to send data or control signaling to the terminal device 10 by using the antenna 2033, and the receiver 2032 is configured to receive information of the terminal device 10 by using the antenna 2033.

In at least one embodiment, the network device in FIG. 2a is an IAB node or a node for relay communication. A name of the relay device is a relay node (RN), a relay transmission reception point (rTRP), an IAB node, or the like. A parent node of the relay node is a gNB (including a gNB-DU, a gNB-CU, and the like), or is another relay node.

As shown in FIG. 2b, the relay node (for example, an IAB node) is divided into an MT and a DU module. The MT is a UE function module of the IAB node, in other words, the IAB node communicates with a parent node by using the MT. The DU is a base station function module of the IAB node, in other words, the IAB node communicates with a child node and UE by using the DU. Both the MT and the DU of the IAB node have complete transceiver modules, and there is an interface between the MT and the DU. However, the MT and the DU are logical modules. In practice, the MT and the DU share a part of submodules, for example, share a transceiver antenna and a baseband processing module.

For ease of understanding at least one embodiment, the following describes an application scenario of at least one embodiment. A network architecture and a service scenario described in at least one embodiment are intended to describe the technical solutions in at least one embodiment more clearly, and do not constitute any limitation on the technical solutions provided in at least one embodiment. A person of ordinary skill in the art knows that, as a new service scenario emerges, the technical solutions provided in at least one embodiment are also applicable to a similar technical problem.

Usually, a relay node establishes a wireless backhaul link to one or more parent nodes, and accesses a core network through the parent node. The parent node controls the relay node by using a plurality of types of signaling (for example, data scheduling, timing modulation, power control). In addition, the relay node provides a service for a plurality of child nodes. The parent node of the relay node is a base station, or is another relay node, and the child node of the relay node is another relay node. In addition, the relay node alternatively provides an access service for UE. A link for communicating with the parent node or the child node is generally referred to as a backhaul link, and a link for communicating with the UE is generally referred to as an access link. In some cases, the parent node is also referred to as an upstream node, and the child node is also referred to as a downstream node.

In-band relay is a relay solution in which a backhaul link and an access link share a same band. Because no additional spectrum resource is used, the in-band relay solution has advantages such as high spectral efficiency and low deployment costs. The in-band relay solution is generally subject to a half-duplex constraint. Specifically, in response to receiving a downlink signal sent by the parent node of the relay node, the relay node cannot send a downlink signal to the child node of the relay node, and in response to receiving an uplink signal sent by the child node of the relay node, the relay node cannot send an uplink signal to the parent node of the relay node. An in-band relay solution of NR is referred to as an integrated access and backhaul (IAB) solution, and the relay node is referred to as an IAB node. With the evolution of technologies, IAB further supports full duplex.

In response to the IAB node operating normally, resource multiplexing is performed on the access link and the backhaul link in a time division manner, a space division manner, or a frequency division manner.

In a time division multiplexing scenario, the backhaul link and the access link operate at different moments. Therefore, the IAB node is to switch between receiving and sending of the backhaul link and receiving and sending of the access link. In response to switching being performed on the backhaul link and the access link with no interval, in other words, in response to symbols of the access link and the backhaul link being consecutive, the IAB node has highest resource utilization. However, during implementation, due to various factors such as power amplifier on/off time, a transmission distance, and non-ideal synchronization, switching with no interval cannot be implemented on the backhaul link and the access link. In this case, the IAB node is to determine a set of available/unavailable symbols of the backhaul link and the access link.

In a space division multiplexing scenario, the backhaul link and the access link operates at a same moment, an MT and a DU of an IAB node simultaneously sends a signal or receives a signal, or the IAB node simultaneously receives a downlink signal sent by the parent node on the backhaul link and an uplink signal sent by the child node/UE on the access link. In this case, spectrum efficiency is improved.

As shown in FIG. 3, a space division receiving scenario of an IAB node #1 is described. In response to all arrow directions in FIG. 3 being reversed, the scenario is a space division sending scenario, in other words, the IAB node #1 sends signals to both a donor and an IAB node #2.

In a space division receiving scenario, a typical problem is power imbalance “power imbalance”, in other words, a difference between a downlink transmission power of a backhaul link and an uplink transmission power of an access link is large. Generally, the downlink transmission power of the backhaul link is far greater than the uplink transmission power of the access link. A parent node uses excessively high power to send a downlink signal. As a result, reception of an uplink signal on an access side of an IAB node DU is affected.

Possible interference to the IAB node during space division receiving affects transmission performance. Therefore, a downlink transmission power adjustment mechanism is introduced. In a standard, the IAB node is supported to report a desired downlink transmit (DL TX) power adjustment amount to the parent node (for example, a donor node), to indicate the parent node to adjust a downlink transmission power of the parent node in a space division slot/symbol. During actual application, the adjustment amount is usually used as a power adjustment amount of a data signal or a power adjustment amount of a reference signal. However, in remaining time division multiplexing slots/symbols (to be specific, the IAB nodes, for example, only one module of an MT or a DU of the IAB node #1 in FIG. 3 operates at a same moment), the parent node does not adjust the downlink transmission power based on the downlink transmission power adjustment amount recommended by the IAB node.

Optionally, the IAB node alternatively indicates an adjustment amount of a downlink transmission power of a child node.

In a recent standard conference (RAN 1 #106e), an IAB downlink power control method is discussed, and the following cases are agreed:

(1) Desired DL-TX power adjustment, indicated by an IAB-MT to a parent node of the IAB-MT to assist with DL-TX power allocation of the parent node, is provided at least for particular time resources.

The desired DL-TX power adjustment is further associated with spatial configuration (for example, a DL RX beam of the MT).

The desired DL TX power adjustment, indicated by the IAB-MT to its parent-node to assist with the parent-node's DL TX power allocation, is provided at least for specific time resources.

The desired DL TX power adjustment is further associated with spatial configuration (e.g., MT's DL RX beams).

(2) Support an IAB node indicating adjustment to a DL-TX power of the IAB node to a child node (for example, in response to receiving DL-TX power assistance information from the child node) at least for specific time resources.

The DL-TX power adjustment indication is further associated with spatial configuration (for example, a DL RX beam of the MT).

Support an IAB-node indicating adjustment to its DL TX power to a child node (e.g., in response to receiving the DL TX power assistance information from the child node) at least for specific time resources.

The DL TX power adjustment indication is further associated with spatial configuration (e.g., MT's DL RX beams).

Currently, UE determines a channel quality indicator (CQI) based on an offset between a downlink reference signal (for example, a channel state information reference signal (CSI-RS)) and a transmission power of a physical downlink shared channel (PDSCH). A reason is as follows: The downlink reference signal received and measured by the UE is the CSI-RS, but the UE is to receive downlink data on the PDSCH. Therefore, a network side is to learn of an equivalent CQI of the UE on the PDSCH, to more accurately schedule the UE (where the CQI represents channel quality, and a higher bit rate and a higher modulation order is used in response to the channel quality being high). To enable the UE to calculate and feed back the CQI corresponding to the PDSCH, a base station configures a ratio of the CSI-RS energy per resource element to PDSCH energy per resource element (EPRE) for the UE. A value range of the ratio is [−8, 15] dB, where dB directly represents an energy ratio of two signals. This is a common representation means in signal processing and communication. For example, 1:1 corresponds to 0 dB. Specifically, for any one of CSI-RS resources, the base station configures a “power control offset powerControlOffset”, where explanation thereof in a protocol is: powerControlOffset: which is the assumed ratio of PDSCH EPRE to NZP CSI-RS EPRE in response to UE deriving CSI feedback and taking values in the range of [−8, 15] dB with 1 dB operation size.

In a current protocol, the base station sends the foregoing configuration to the UE in CSI-RS resource configuration by using RRC signaling.

For common UE, because space division multiplexing of a backhaul link and an access link (that is, simultaneously reception or sending of both sides) does not need to be considered, in response to the CSI-RS resource configuration being designed in an existing protocol, only the ratio of the CSI-RS EPRE to the PDSCH EPRE is to be configured.

To reduce interference during space division multiplexing, a downlink transmission power adjustment mechanism is introduced in an IAB solution, and a parent node of the IAB node reduces a downlink transmission power. In response to the IAB node calculating the CQI, a downlink power of the PDSCH is to be assumed. The downlink power of the PDSCH is obtained based on a power of the CSI-RS and the ratio of the PDSCH EPRE to the CSI-RS EPRE. In response to the IAB node calculating the CQI based on a downlink transmission power before adjustment (in other words, a PDSCH EPRE assumption that the parent node does not adjust a downlink power during time division multiplexing), scheduling performed by the parent node based on the CQI is inaccurate. For example, in response to the parent node performing scheduling, a modulation order or a code rate is excessively high, and a transmission power is high, but a PDSCH transmission power during actual space division multiplexing is not so high. As a result, the IAB node (IAB-MT) correctly receiving a demodulation signal is difficult.

Based on this, at least one embodiment provides a solution of how the parent node (for example, a donor node) configures and indicates a power ratio of a CSI-RS to a PDSCH for space division multiplexing in response to the IAB-MT being in different transmission modes (space division or time division), and a solution of how the IAB-MT distinguishes between reported information based on two power ratios of a CSI-RS to a PDSCH for feeding back CSI, in other words, which reported CQI is for time division multiplexing (calculated based on an unadjusted PDSCH downlink transmission power) and which reported CQI is for space division multiplexing (calculated based on an adjusted PDSCH downlink transmission power).

The following describes the solution in detail with reference to the accompanying drawings. Features or content denoted by dashed lines in the accompanying drawings are understood as optional operations or optional structures in at least one embodiment.

In at least one embodiment, a first message is replaced with first information, a second message is also replaced with second information, a third message is also replaced with third information, and a fourth message is also replaced with fourth information. A plurality of pieces of information is sent in one message, or is sent in a plurality of messages.

In an example, a first node and a second node in at least one embodiment are in a direct connection relationship, in other words, there is no intermediate node between the first node and the second node, and the second node is a parent node of the first node. For example, the first node is a child IAB node, or an MT of the child IAB node, and the second node is a parent IAB node, or a DU of the parent IAB node, or is a donor node.

In an example, a first node and a second node in at least one embodiment is alternatively in an indirect connection relationship, in other words, there is an intermediate node between the first node and the second node. For example, the first node is a child IAB node, or an MT of the child IAB node, and the second node is a donor. For example, one or more intermediate nodes (for example, an intermediate IAB node) are further deployed between the first node and the second node.

As shown in FIG. 4, a communication method is provided. The method includes the following operations.

Step 401: A second node sends a first message to a first node, and correspondingly, the first node receives the first message from the second node.

The first message indicates a first ratio corresponding to a first downlink reference signal. The first ratio is a power ratio that is between data and a downlink reference signal and that is obtained after downlink transmission power adjustment performed by a parent node.

A configuration granularity of the ratio is a downlink reference signal, a CSI-RS resource, a TCI state, another equivalent manner that represents a beam, another CSI-RS resource having a QCL relationship with a CSI-RS resource, or another CSI-RS resource indicated by beam indication information (for example, a TCI state or QCL information) as a specific CSI-RS resource or ID. In at least one embodiment, a downlink reference signal corresponding to the first ratio is referred to as the first downlink reference signal.

The ratio mentioned in at least one embodiment is a power ratio between data and a downlink reference signal. A second ratio is a power ratio used before the downlink transmission power adjustment, and the first ratio is a power ratio obtained after the downlink transmission power adjustment.

Optionally, “obtained after the downlink transmission power adjustment” is replaced with “measured in a space division mode”. In other words, in an optional example, the first ratio is a power ratio that is between data and a downlink reference signal and that is measured in a space division mode. For example, a value range of the first ratio is [−8, 15] dB, where dB directly represents an energy ratio of two signals. This is a common representation means in signal processing and communication. For example, 1:1 corresponds to 0 dB. The value range of the first ratio is alternatively another value and another range. This is not limited in at least one embodiment.

Optionally, “used before the downlink transmission power adjustment” is replaced with “measured in a time division mode”. In other words, in an optional example, the second ratio is a power ratio that is between data and a downlink reference signal and that is measured in a time division mode. A value range of the second ratio is [−8, 15] dB, where dB directly represents an energy ratio of two signals. This is a common representation means in signal processing and communication. For example, 1:1 corresponds to 0 dB.

A power ratio between data and a downlink reference signal is also replaced with a power ratio of PDSCH EPRE to NZP CSI-RS EPRE.

In addition, a power ratio between A and B is a ratio of A to B, or is a ratio of B to A.

Step 402: The first node sends a second message to the parent node, and correspondingly, the parent node receives the second message from the first node.

The second message includes a first measurement result. The first measurement result is determined based on the first ratio, and the first measurement result is determined based on the first downlink reference signal.

The parent node of the first node is the same as or different from the second node. Refer to the foregoing descriptions.

The measurement result is a CSI measurement result (CSI reporting), and the CSI measurement result includes a CQI measurement result.

The measurement result is reported at a granularity of a reference signal.

In at least one embodiment, the power ratio that is between the data and the downlink reference signal and that is obtained after the downlink transmission power adjustment (or that is measured in the space division mode) is configured for the first node, so that the first node reports, to the parent node, the measurement result obtained based on the power ratio that is between the data and the downlink reference signal and that is obtained after the downlink transmission power adjustment (or that is measured in the space division mode). In this case, the parent node obtains the measurement result (for example, a CQI measurement result) during measurement in the space division mode, so that the parent node determines a transmission parameter such as an MCS (modulation and coding scheme, modulation and coding scheme) for downlink transmission scheduling in a space division slot (after the downlink transmission power adjustment), and communication performance is improved.

In an optional example, the second message further includes a second measurement result. The second measurement result is determined based on the second ratio, and the second measurement result is determined based on the first downlink reference signal. The second ratio is a power ratio that is between data and a downlink reference signal and that is used before the downlink transmission power adjustment performed by the parent node.

The first node not only reports the first measurement result obtained based on the first ratio, but also reports the second measurement result obtained based on the second ratio, so that the parent node determines a transmission parameter such as an MCS for downlink transmission scheduling in a time division slot (before the downlink transmission power adjustment), and communication performance is improved. The second ratio is configured for the first node in downlink reference signal resource configuration information. Generally, the downlink reference signal resource configuration information is for configuring a resource ID, a time-frequency position of resource mapping, and the like.

The second measurement result and the first measurement result are sent to the parent node in one message, or is sent to the parent node in a plurality of messages.

During actual use, the parent node sends a reference signal to the first node on different resources, for example, sends the reference signal on some resources by using a downlink transmission power before adjustment, or send the reference signal on some resources by using a downlink transmission power after adjustment. A specific resource on which the signal is actually sent by using the adjusted downlink transmission power is a time resource preconfigured by a donor node or the parent node, for example, a set of slot indexes, or is dynamically indicated by a parent node DU.

The measurement result is reported at the granularity of the reference signal, or the measurement result is reported by using a granularity of a beam.

In response to a beam for measuring the first downlink reference signal being a beam associated with a downlink power control beam (namely, a first beam), the first node determines to report the first measurement result corresponding to the beam for measuring the first downlink reference signal, or determine to report the first measurement result and the second measurement result that correspond to the beam for measuring the first downlink reference signal. In response to a beam for measuring the downlink reference signal not being a beam associated with a downlink power control beam (namely, a first beam), the first node determines to report the second measurement result corresponding to the beam for measuring the downlink reference signal.

The downlink power control beam means that a downlink transmission power adjustment amount of a beam is reported by using a mechanism supported in a conventional technology, and the parent node responds to the beam for downlink transmission power adjustment. Then, the beam is referred to as the downlink power control beam.

Beam association is understood as that two beams have a same ID, or two beams have a QCL relationship. To be specific, that the beam for measuring the first downlink reference signal is associated with the downlink power control beam is understood as that a beam ID of the beam for measuring the first downlink reference signal is the same as that of the downlink power control beam, or the beam for measuring the first downlink reference signal has a QCL relationship with the downlink power control beam.

For example, in response to the beam for measuring the first downlink reference signal being a beam 1, or beam indication information of a reference signal that is to be measured indicates the beam 1, and the beam 1 has an association relationship with the downlink power control beam (namely, the first beam), only a first measurement result corresponding to the beam 1 is reported, or the first measurement result and a second measurement result that correspond to the beam 1 is reported.

For example, in response to the beam for measuring the first downlink reference signal being a beam 2, or beam indication information of a reference signal that is to be measured indicates the beam 2, and the beam 2 has no association relationship with the downlink power control beam (namely, the first beam), only a second measurement result corresponding to the beam 2 is reported.

The foregoing beam indication method for measuring a reference signal is performed based on an existing technical means in a 3GPP standard protocol, and details are not described herein.

In an optional example, the first measurement result is a measurement result corresponding to the beam for measuring the first downlink reference signal, and the beam for measuring the first downlink reference signal is a beam associated with the downlink power control beam (where the downlink power control beam is a beam on which downlink transmission power adjustment is performed, namely, the first beam described below).

In an optional example, the second measurement result is a measurement result corresponding to the beam for measuring the first downlink reference signal. For example, the second measurement result is a measurement result corresponding to the beam for measuring the first downlink reference signal, that is, a result obtained by measuring the first downlink reference signal by an MT by using a configuration indicated by a TCI state ID indicated by a beam, or QCL information based on which the first downlink reference signal is measured, where the QCL information is QCL information indicated by the first beam, and the beam for measuring the first downlink reference signal is a beam that is associated with the downlink power control beam (namely, the first beam). Alternatively, the second measurement result is a measurement result corresponding to the beam for measuring the first downlink reference signal, and the beam for measuring the first downlink reference signal is a beam that is not associated with the downlink power control beam (namely, the first beam).

For example, the beam for measuring the first downlink reference signal includes the beam 1, the beam 2, and a beam 3. In the three beams, the beam 1 has an association relationship with the downlink power control beam (namely, the first beam). In response to the first measurement result being reported, the first measurement result of the beam 1 is reported. In response to the second measurement result being reported, second beam measurement results respectively corresponding to the beam 1, the beam 2, and the beam 3 is reported. Alternatively, only the second measurement result of the beam 1 is reported, and the second beam measurement results of the beam 2 and the beam 3 are not reported. Alternatively, only the second measurement results of the beam 2 and the beam 3 are reported, and the second beam measurement result of the beam 1 is not reported.

Indication information of the beam for measuring the first downlink reference signal is configured in RRC signaling. For example, for a periodic downlink reference signal (for example, a CSI-RS), beam indication information of the periodic downlink reference signal is configured in a CSI-RS resource configuration. For measurement and reporting of an periodic downlink reference signal (for example, a CSI-RS) or an aperiodic downlink reference signal (for example, a CSI-RS), beam indication information of the periodic downlink reference signal or the aperiodic downlink reference signal is configured in a reporting configuration associated with CSI. To be specific, the parent node or the base station triggers different reporting configurations, to achieve an effect of measuring a downlink reference signal by using different beams. Beam indication information of a semi-persistent (Semi-persistent) CSI-RS is indicated by sending MAC-CE signaling by the parent node or the base station.

The following respectively describes aperiodic, semi-persistent, and periodic measurement modes.

For aperiodic CSI measurement and reporting in the conventional technology, a base station configures, for UE, a beam (TCI state) used during measurement. For an IAB herein, in response to a beam based on aperiodic CSI measurement being a beam associated with downlink power control, results in two modes need to be reported, or only a result in the space division mode is to be reported.

The beam associated with the downlink power control means that an IAB-MT reports a downlink transmission power adjustment amount by using the mechanism supported in the conventional technology. The adjustment amount (which is usually a power adjustment amount of data) is configured for a downlink reference signal of the parent node, and/or is configured for a downlink beam (for example, a TCI state, or a TCI state of a downlink reference signal used by a QCL type-D).

That the results in the two modes are reported means that the IAB-MT reports measurement results (for example, CQI measurement results) obtained through calculation by using two assumed power ratios (for example, power ratios of PDSCH EPRE to CSI-RS EPRE).

That only the result in the space division mode is reported means that a measurement result (for example, a CQI measurement result) calculated by using the first ratio is reported.

For semi-persistent CSI measurement, in response to a TCI corresponding to a CSI-RS resource set (CSI-RS resource set) for which activated semi-persistent CSI measurement and reporting is performed being a beam related to downlink power control, results in two modes need to be reported, or only a result in the space division mode is to be reported. In the conventional technology, a beam of a semi-persistent CSI-RS is configured by the base station by using RRC signaling.

For periodic CSI measurement and reporting, in a case in which a beam configured for the periodic CSI measurement and reporting is a beam related to downlink power control (in the conventional technology, a beam of a periodic CSI-RS is configured by the base station by using RRC signaling), in response to the first ratio not being received, the IAB-MT reports only a CQI result in a time division multiplexing mode. In response to the first ratio being received, results in two modes need to be reported, or only a result in the space division mode is to be reported.

In an optional example, the first node further sends a fourth message to the parent node. The fourth message indicates a downlink transmission power adjustment amount desired by the first node and a second beam corresponding to the desired downlink transmission power adjustment amount. Optionally, the parent node indicates, to the first node, a downlink transmission power adjustment amount used by the parent node and a corresponding first beam.

The downlink transmission power adjustment amount mentioned in at least one embodiment is usually a transmission power adjustment amount of downlink data, and both the first ratio and the second ratio are power ratios between the data and the downlink reference signal. In this case, the first node calculates the first measurement result based on the transmission power adjustment amount of the downlink data and the first ratio, and further calculates the second measurement result based on the transmission power adjustment amount of the downlink data and the second ratio.

Optionally, the downlink transmission power adjustment amount is alternatively a transmission power adjustment amount of the downlink reference signal. In this case, the power ratio between the data and the downlink reference signal is alternatively replaced with a power ratio between a synchronization signal (for example, a secondary synchronization signal (SSS)) and the downlink reference signal. In other words, both the first ratio and the second ratio are power ratios between the synchronization signal (for example, the secondary synchronization signal) and the downlink reference signal. In this case, the first node calculates the first measurement result based on the transmission power adjustment amount of the downlink reference signal and the first ratio, and further calculates the second measurement result based on the transmission power adjustment amount of the downlink reference signal and the second ratio. Alternatively, information for configuring or indicating the downlink transmission power adjustment amount includes not only the downlink transmission power adjustment amount, to be specific, the transmission power adjustment amount of the downlink reference signal, but also the transmission power adjustment amount of the downlink data.

The power ratio between the secondary synchronization signal SSS and the downlink reference signal is a power ratio between a CSI-RS RE and an SSS RE. The ratio is configured through a Power offset of NZP CSI-RS RE to SSS RE field.

In response to the second node being the parent node, the first message is a new message, or the first message is a message for updating CSI-RS resource configuration information.

An example in which the second node is an IAB node (or a DU of the IAB node) is described.

The first node is directly connected to the second node, and the second node is the parent node of the first node.

In response to the second node being the IAB node (or the DU of the IAB node), the first message is a new message, or the first message is a message for updating CSI-RS resource configuration information.

In response to the second node being the IAB node (or the DU of the IAB node), the first message further indicates the downlink transmission power adjustment amount used by the second node (namely, the parent node) and the corresponding first beam. The first message is referred to as a downlink power control response message. In at least one embodiment, an existing downlink power control response message carries information about the first ratio. An existing message is used as the first message, so that signaling exchange is reduced.

In an optional example, in response to the second node being the IAB node (or the DU of the IAB node), the first message further indicates the first beam. The first ratio further implicitly indicates the downlink transmission power adjustment amount used by the second node (namely, the parent node). In other words, the downlink transmission power adjustment amount used by the second node (namely, the parent node) does not need to be additionally indicated in the first message.

The downlink transmission power adjustment is performed on the first beam, and the first beam is also referred to as a downlink power control beam.

The first message is carried in L1 signaling or L2 signaling. L1/L2 signaling indication includes indicating the first ratio by using a MAC-CE or DCI signaling.

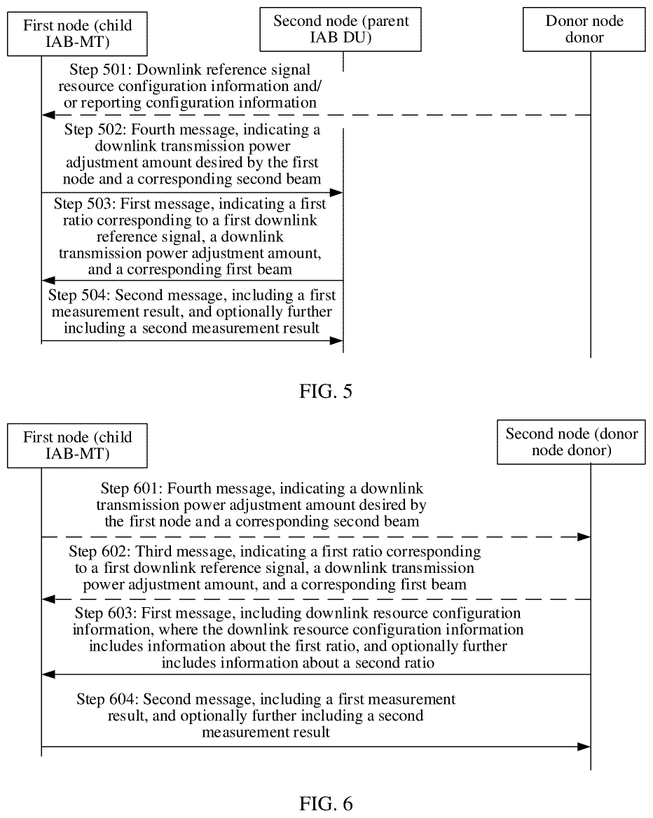

As shown in FIG. 5, a communication method is described. In the method, a parent IAB node (a DU of the parent IAB node) configures a first ratio for a child IAB node (an MT of the child IAB node). In other words, a first node is the MT of the child IAB node (which is referred to as a child IAB-MT for short), and a second node is a DU of the parent IAB node (which is referred to as a parent IAB DU for short).

The method includes the following operations.

Optionally, operation 501: A donor node sends downlink reference signal resource configuration information and/or reporting configuration information to the first node (the child IAB-MT).

For example, the donor sends the downlink reference signal resource configuration information to the child IAB-MT by using RRC signaling, to configure a resource for the child IAB-MT to perform downlink reference signal measurement and feedback. The donor is a parent node of the parent IAB node. In other words, the parent IAB node is further set between the donor and the child IAB node. For the downlink reference signal resource configuration information and/or the reporting configuration information, the parent IAB node is used for transparent transmission. A downlink reference signal is, for example, a CSI-RS.

In the downlink reference signal (for example, CSI-RS) resource configuration information, for any downlink reference signal resource, a resource ID, a time-frequency position of resource mapping, and a second ratio of the downlink reference signal is configured. The second ratio is a power ratio that is between data and the downlink reference signal (a PDSCH RE and a CSI-RS RE (resource element)) and that is measured in a time division mode. Optionally, for a downlink reference signal measured in a periodic or semi-persistent manner, a periodicity and a time domain position offset of the downlink reference signal is further configured.

The reporting configuration information includes but is not limited to one or more of the following: a measurement resource, a reporting manner (periodic reporting, semi-persistent reporting, or aperiodic reporting), a reported measurement amount (L1-RSRP, L1-SINR, or CQI reporting), a reported resource (for example, a PUCCH configuration), and the like. Correspondingly, in addition to the CQI, a reported measurement result further includes L1-reference signal received power (RSRP), L1-signal to interference plus noise ratio (SINR), a precoding matrix indicator (PMI), a rank indicator (RI, a layer indicator (L1), or the like.

The foregoing operation 501 is alternatively not performed.

Step 502: The first node (the child IAB-MT) sends a fourth message to the second node (the parent IAB DU, which is also a parent node), and correspondingly, the second node receives the fourth message from the first node.

The fourth message indicates a downlink transmission power adjustment amount desired by the first node and a second beam corresponding to the desired downlink transmission power adjustment amount.

Downlink transmission power adjustment is performed at a granularity of a beam. In at least one embodiment, a beam on which the first node expects to perform downlink transmission power adjustment is referred to as the second beam. The second beam is a part or all of beams in configured beams. The configured beam refers to a TCI state configured by the donor for the first node (the child IAB-MT), and is a beam for communication between the first node and the parent IAB node, for example, an activated TCI state. In at least one embodiment, downlink transmission power adjustment is also applicable to all other beams associated with the configured beam.

The child IAB node reports a desired downlink transmission power adjustment amount and corresponding beam information to the parent node, so that the MT and a DU of the child IAB node perform space division multiplexing reception.

In an optional example, the second node (the parent IAB DU) further sends, to the parent node of the second node, a downlink transmission power adjustment amount desired by the second node and a beam corresponding to the desired downlink transmission power adjustment amount.

In an optional example, the second node sends the fourth message to the parent node of the second node until the fourth message is sent to the donor, and the second node (the parent IAB node) is used for transparent transmission in this process.

Step 503: The second node (the parent IAB DU) sends a first message to the first node (the child IAB-MT), and correspondingly, the first node receives the first message from the second node.

The first message indicates a first ratio corresponding to a first downlink reference signal, and the first message further indicates a downlink transmission power adjustment amount used by the second node and a corresponding first beam. For example, the first message includes at least one of the following information: an identifier of a downlink reference signal resource, a first beam ID, and a TCI state ID corresponding to the first beam, where the TCI state ID indicates a beam.

The first message is referred to as a downlink power control response message. In at least one embodiment, an existing downlink power control response message carries information about the first ratio.

The first beam is the same as the second beam, in other words, the second node agrees to adjust all second beams.

Alternatively, in response to there being a plurality of second beams, the first beam is a part of the second beams, in other words, the second node agrees to adjust only a part of beams in the second beams.

Optionally, the first message does not include the downlink transmission power adjustment amount used by the second node (namely, the parent node). The first ratio further implicitly indicates the downlink transmission power adjustment amount used by the second node (namely, the parent node). Therefore, the downlink transmission power adjustment amount used by the second node (namely, the parent node) does not need to be additionally indicated in the first message.

Step 504: The first node (the child IAB-MT) sends a second message to the second node (the parent IAB DU), and correspondingly, the second node receives the second message from the first node. The second message includes a first measurement result and/or a second measurement result.

The first measurement result is determined based on the first ratio, and the second measurement result is determined based on the second ratio. The first measurement result and the second measurement result are determined based on the first downlink reference signal.

In a case in which the measurement result is reported at a granularity of a beam:

In response to a beam for measuring the first downlink reference signal being a beam associated with a downlink power control beam (namely, the first beam), the first node reports the first measurement result corresponding to the beam for measuring the first downlink reference signal, or reports the first measurement result and the second measurement result corresponding to the beam for measuring the first downlink reference signal.

In response to a beam for measuring the downlink reference signal not being a beam associated with a downlink power control beam (namely, the first beam), the first node reports the second measurement result corresponding to the beam for measuring the downlink reference signal.

For specific details, refer to the foregoing descriptions. Details are not described herein again.

The following uses an example in which the second node is a donor to describe another example.

For example, in response to the second node being a donor node, the first message includes the downlink reference signal resource configuration information. In other words, the second ratio and existing downlink reference signal resource configuration information are configured in one message. An existing message is used as the first message, so that signaling exchange is reduced.

For example, the information about the first ratio is located in the downlink reference signal resource configuration information.

In a conventional technology, the downlink reference signal resource configuration information includes the second ratio measured in a time division mode. In at least one embodiment, in the downlink reference signal resource configuration information, two ratios are configured for one reference signal resource, in other words, two ratios measured in the time division mode and in a space division mode are both configured by using the downlink reference signal resource configuration information. Alternatively, in the downlink reference signal resource configuration information, only one ratio is configured for one reference signal resource. For example, the second ratio measured in the time division mode in the downlink reference signal resource configuration information is replaced with the second ratio measured in a space division mode.

As shown in FIG. 6, a communication method is described. In the method, a donor configures a first ratio for a child IAB node (an MT of the child IAB node). In other words, a first node is an MT of a child IAB node (which is referred to as a child IAB-MT for short), and the second node is the donor. In response to an intermediate node IAB being deployed between the first node and the second node, the intermediate node IAB is a parent node of the first node. In response to the first node being directly connected to the second node, the second node is a parent node of the first node. FIG. 6 shows an example in which the second node is the parent node of the first node for description.

The method includes the following operations.

Optionally, operation 601: The first node (the child IAB-MT) sends a fourth message to the second node (the donor), and correspondingly, the second node receives the fourth message from the first node.

The fourth message indicates a downlink transmission power adjustment amount desired by the first node and a second beam corresponding to the desired downlink transmission power adjustment amount.

Optionally, operation 602: The second node (the donor) sends a third message to the first node (the child IAB-MT), and correspondingly, the first node receives the third message from the second node.

The third message indicates a downlink transmission power adjustment amount used by the second node and a corresponding first beam.

In addition, the first ratio further implicitly indicates the downlink transmission power adjustment amount used by the parent node. Therefore, the third message does not need to be additionally sent, to indicate the downlink transmission power adjustment amount used by the second node (namely, the parent node).

Step 603: The second node (the donor) sends a first message to the first node (the child IAB-MT). The first message includes downlink reference signal resource configuration information.

The downlink reference signal resource configuration information includes information about the first ratio corresponding to a first downlink reference signal, and optionally, further includes information about a second ratio.

Optionally, the first message further includes reporting configuration information.

The first message is configured by using RRC signaling.

A sequence of operation 601 and operation 602 is not limited, and a sequence of operation 601 and operation 603 is not limited either.

Step 604: The first node (the child IAB-MT) sends a second message to the second node (the donor), and correspondingly, the second node receives the second message from the first node. The second message includes a first measurement result and/or a second measurement result.

For a process of operation 604, refer to operation 504. Details are not described again.

For example, in response to the second node being the donor node, the first message is, for example, a message for updating CSI-RS resource configuration information, or newly defined signaling indicating a power ratio. The first message is carried in the RRC signaling.

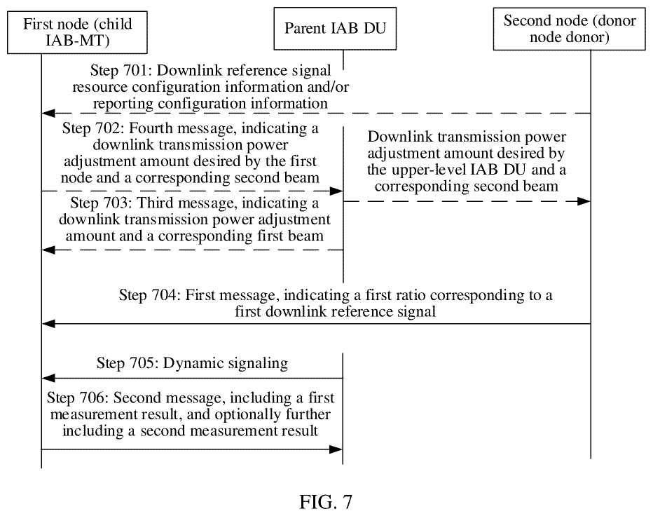

As shown in FIG. 7, a communication method is provided. In the method, a donor configures a first ratio for a child IAB node (an MT of the child IAB node). In other words, a first node is an MT of a child IAB node (which is referred to a child IAB-MT for short), and a second node is the donor. In response to an intermediate node IAB being deployed between the first node and the second node, the intermediate node IAB is a parent node of the first node. In response to the first node being directly connected to the second node, the second node is the parent node of the first node. FIG. 7 shows an example in which the intermediate node IAB is deployed between the first node and the second node for description.

The method includes the following operations.

Optionally, operation 701: The second node (the donor) sends downlink reference signal resource configuration information and/or reporting configuration information to the first node (the child IAB-MT).

This process is the same as that of operation 501 described above, and details are not described again.

Optionally, operation 702: The first node (the IAB-MT) sends a fourth message to the parent node (for example, a parent IAB DU), and correspondingly, the parent node receives the fourth message from the first node.

The fourth message indicates a downlink transmission power adjustment amount desired by the first node and a second beam corresponding to the desired downlink transmission power adjustment amount.

In an optional example, the parent node sends the fourth message to a parent node of the parent node until the fourth message is sent to the second node donor.

For this process, refer to operation 502 described above. Details are not described again.

Optionally, Step 703: The parent node (for example, the parent IAB DU) sends a third message to the first node (the child IAB-MT), and correspondingly, the first node receives the third message from the parent node.

The third message indicates a downlink transmission power adjustment amount used by the parent node and a corresponding first beam.

In addition, the first ratio further implicitly indicates the downlink transmission power adjustment amount used by the parent node. Therefore, the third message does not need to be additionally sent, to indicate the downlink transmission power adjustment amount used by the second node (namely, the parent node).

Step 704: The second node (the donor) sends a first message to the first node (the child IAB-MT), and correspondingly, the first node receives the first message from the second node. The first message indicates the first ratio corresponding to a first downlink reference signal.

A sequence of operation 704, operation 701, operation 702, and operation 703 is not limited.

Optionally, operation 705: The parent node (for example, the parent IAB DU) sends dynamic signaling (for example, a MAC-CE or a PDCCH) to the first node (the child IAB-MT). The dynamic signaling is for binding the first ratio (for example, a power ratio of PDSCH EPRE to NZP CSI-RS EPRE) on a report ID, a trigger state, a CSI-RS resource, or a beam.

In an example, MAC-CE signaling indicates that the power ratio that is of the PDSCH EPRE to the NZP CSI-RS EPRE, that is used for a space division mode, and that corresponds to Report ID A is B. After the Report ID A is triggered, the IAB-MT (the first node) is to perform measurement and reporting based on pre-obtained configuration information, where a measurement result (for example, a CQI) is calculated based on the power ratio B, and the result is reported. Alternatively, both a time division measurement result and a space division measurement result are reported.

In a conventional technology, the trigger state is a DCI bit sequence used by a base station to trigger UE to perform aperiodic measurement and reporting. In response to a specific trigger state being configured, for example, “001010” is associated with report ID #2, in response to the UE receiving the bit sequence “001010” in a CSI request field of DCI, the UE determines that a measurement configuration that a network expects to trigger is a reporting configuration corresponding to report ID #2, where the reporting configuration includes a reference signal resource identifier.

In this embodiment, the specific trigger state is bound to space division multiplexing reporting by using a pre-configuration method. In response to receiving, in the CSI request field of the DCI sent by the parent node DU, a bit sequence that is preconfigured to be bound to reporting of the space division result, the IAB-MT measures and calculates a measurement result (for example, a CQI) by using the obtained ratio, and reports the measurement result.

In another example, the parent node switches, by using dynamic signaling, a power ratio (for example, a power ratio of PDSCH EPRE to NZP CSI-RS EPRE) used for CSI reporting, in other words, switches a time division measurement result or a space division measurement result reported by a child node MT. Alternatively, both the time division measurement result and the space division measurement result are reported.

The dynamic signaling is the DCI or a MAC-CE. For example, a bit is added to the DCI to indicate a reporting state of the measurement result. For example, in response to the bit being 0, CSI reporting triggered by the DCI includes only a time division multiplexing result (to be specific, a measurement result is not calculated by using a first ratio that is newly configured but is calculated by using only a second ratio). For example, in response to the bit being 1, CSI reporting triggered by the DCI includes a space division multiplexing result. Alternatively, in response to the bit being 1, both the time division measurement result (determined based on the second ratio) and the space division measurement result (determined based on the first ratio) are reported. In addition to introducing a new field, an existing field or some existing fields is alternatively redefined/interpreted, to implement the foregoing functions.

Step 706: The first node sends a second message to the parent node (for example, the parent IAB DU), and correspondingly, the parent node receives the second message from the first node. The second message includes a first measurement result and/or a second measurement result.

For a process of operation 706, refer to operation 504. Details are not described again.

In some cases, the IAB node includes a DU part and an MT part. For any IAB node 1, the IAB node 1 is to enable arrival time of a downlink signal sent by a parent node 2 (for example, a DU of a parent IAB node or a donor) to an MT of the IAB node 1 to be aligned with arrival time of an uplink signal sent by a child node 3 (for example, an MT of a child IAB node or UE) of the IAB node 1 to a DU of the IAB node 1. Based on a principle of OFDM signals, symbol-aligned OFDM signals are orthogonal to each other, and inter-carrier interference is not generated. Therefore, signal arrival time is aligned, which facilitates the IAB node to perform space division reception.

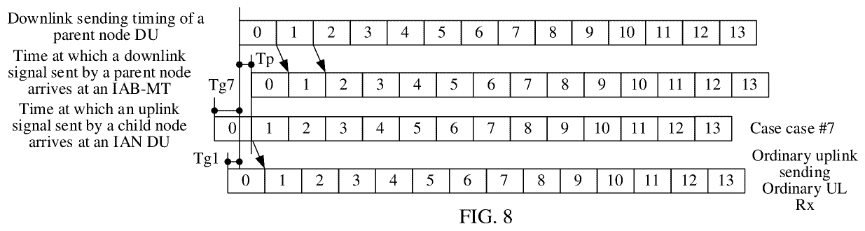

FIG. 8 provides an example of timing alignment. Symbol-level alignment is performed on time (symbol 1 #) at which the uplink signal sent by the child node 3 arrives at the DU of the IAB node 1 and time (symbol 0 #) at which the downlink signal sent by the parent node 2 arrives at the MT of the IAB node 1, that is, a position shown by a vertical line in the figure. Because #0 is not aligned to #0, the timing alignment is not slot/subframe-level alignment.

However, a bottom row in FIG. 8 indicates time at which uplink sending of the child node IAB-MT in a non-space receiving slot of the parent node arrives at the parent node DU, in other words, the child IAB-MT uses arrival time in Case 1 timing in the key terms. There is a fixed offset between the arrival time and arrival time of Case 7, where the fixed offset is referred to as an offset in a standard.

From FIG. 8, Tg7=Tg1+offset, and Tg7+Tp=symbol duration. Tp indicates a transmission delay of a signal from the parent node to the IAB-MT. The following is obtained based on the foregoing two equations:

Tg1+offset+Tp=symbol duration, where Tg1 is a timing difference between uplink reception and downlink sending. A range of a value of Tg1 during implementation is defined in a protocol, and the value is generally referred to as TA_offset in the protocol. In addition, because an IAB node is fixedly deployed, and a Tp transmission delay is related to a broadcast distance, Tp is also a fixed value. Therefore, in order to enable the equation to be true, the offset is directly related to the symbol duration.

In response to a space division problem of the IAB not being considered, in response to conventional UE or the IAB node operating only in a time division multiplexing mode, uplink sending timing is determined by using a timing advance (timing advance, TA) in a conventional technology. A base station (a parent DU of the IAB node) controls/adjusts a value of the TA by using MAC-CE signaling, to control uplink sending time of the UE or the child IAB-MT.

In the conventional technology, a relationship between the offset and the symbol duration is not considered. However, actually, a duration of an OFDM symbol is related to a subcarrier spacing. Therefore, this at least one embodiment provides a solution, so that an IAB node accurately determines an offset used by the IAB node for enabling Case 7 timing and for space division multiplexing.

For example, the IAB node or the donor node indicates an offset of the uplink sending timing to the child IAB node MT, where the offset is for determining the uplink sending timing. The sending timing takes effect only in some slots, and the sending timing is obtained based on the TA plus an offset value. An effective slot is a slot index set preconfigured by the parent node or the donor node, or is configured as a part of a multiplexing parameter set. The multiplexing parameter set indicates a parameter that should be used in response to the IAB node performing multiplexing sending or reception.

Optionally, the configuration parameter includes one or more of the following information.

Information 1: a setting situation of a guard band among frequency bands during communication transmission, indicating whether the guard band is used in response to an MT and a DU that are of a relay node performing frequency division multiplexing.

Information 2: a guard band size, indicating, in response to frequency division multiplexing being performed for access and backhaul of the relay node, a size of a frequency domain resource reserved between a frequency domain resource used by the MT and a frequency domain resource used by the DU, where the reserved frequency domain resource is not used by the MT or the DU. For example, the =guard band size is represented by a quantity of physical resource blocks (PRBs, physical resource blocks).

Information 3: a quantity of guard symbols, indicating time used for switching between the MT and the DU of the relay node during operation.

Information 4: an undesired beam set, indicating that the relay node performs space division on the MT and the DU.

Information 5: a carrier frequency TRx quantity, indicating a quantity of ports that is used in access or backhaul communication in response to the relay node performing space division multiplexing or frequency division multiplexing.

Information 6: a setting situation of a downlink receive power interval of the mobile terminal MT of the relay node, indicating a range or an adjustment amount of a downlink transmission power desired by the MT in response to the relay node performing space division reception, for example, reducing X dB based on a downlink transmit signal power of a current parent node.

Information 7: a maximum quantity of demodulation reference signal DMRS ports for downlink scheduling of the MT of the relay node.

Information 8: a maximum quantity of DMRS ports for uplink scheduling of the MT of the relay node.

Information 9: a set of effective slots, indicating slots to which the multiplexing transmission parameter should be used.

The foregoing information is configured in one piece of signaling, or is configured in a plurality of pieces of signaling. This is not limited in at least one embodiment. Alternatively, one or more of the foregoing information is separately configured as a plurality parameter sets in the plurality of pieces of signaling, and a parent node of the relay node further associates the plurality of parameter sets by using dynamic signaling, and indicate that the relay node is effective and applied.

For example, a donor base station or the parent node of the relay node configures a plurality of groups of configuration parameters by using signaling, and each group of configuration parameters includes one or more of the foregoing information. Each group of parameters is identified by one ID, as shown in the following structure.

### Multiplexing Parameter Configuration:

{
Parameter set ID
Slot set: Sequence {0,40}
Frequency division multiplexing: Select {Yes, No} (optional)
Guard band size: Select {2, 4, 8, 16, 32, 64} (optional)
Desired beam: TCI state ID #Y (optional)
...
}

The foregoing parameters are also reported by the relay node to the parent node or the donor node. In other words, after a parameter desired by the relay node is reported, the parent node or the donor node configures the parameter for the relay node.

The parent node of the relay node further indicates, by using DCI signaling or MAC-CE signaling, one parameter set ID, which indicates an effective parameter set of the relay node. After the indicated parameter set takes effect, the relay node performs space division transmission on a preconfigured space division transmission time resource based on the parameter indicated by the parameter set.

For example, the donor base station or the parent node of the relay node configures a plurality of groups of configuration parameters by using signaling, and each group of configuration parameters includes one or more of the foregoing information. Each group of parameters is identified by one ID, as shown in the following structure.

### Multiplexing Parameter Configuration:

{
Parameter set ID
Frequency division multiplexing: Select {Yes, No} (optional)
Guard band size: Select {2, 4, 8, 16, 32, 64} (optional)
Desired beam: TCI state ID #Y (optional)
...
}

The foregoing parameters are also reported by the relay node to the parent node or the donor node. In other words, after a parameter desired by the relay node is reported, the parent node or the donor node configures the parameter for the relay node.

The parent node of the relay node further indicates, by using DCI signaling or MAC-CE signaling, one parameter set ID, which indicates an effective parameter set of the relay node. After the indicated parameter set takes effect, the relay node performs space division transmission on a preconfigured space division transmission time resource based on the indicated parameter.

Optionally, a signaling format is as follows:

```
  MultiplexingParameters information element
  -- ASN1START
  -- TAG- MultiplexingParameters-Mode-START
```

| | |
|---|---|
| MultiplexingParametersSet::= | SEQUENCE { |
| MultiplexingParametersSet -Id | MultiplexingParametersSet -Id, |
| FDM | ENUMERATED {on, off} |
| Guardband | ENUMERATED {2,4,6,8,16,32,64} |
| DLpowercontrol | INTEGER {−8, 15} |
| ULpowercontrol | INTEGER {−20, 23} |
| tci-StateId | TCI-StateId, |
| srs-ResourceSetId | SRS-ResourceSetId |
| MaxMIMO-LayersDL-r16 ::= | INTEGER (1..8) |
| Timingmode | ENUMERATED {Case6, Case7} |
| Slotset | SEQUENCE (SIZE (1..maxSlot-frame)) OF |

```
slotIdx
  }
  -- TAG- MultiplexingParameters-STOP
  -- ASN1STOP
```

In at least one embodiment, the IAB node or the donor node sends signaling to the child IAB node MT, where the signaling includes a plurality of offset values and subcarrier spacings corresponding to the plurality of offset values.

(a) In response to a specific SCS (subcarrier spacing) being used for an active uplink BWP (bandwidth part, bandwidth part) of the child IAB-MT, the child IAB-MT obtains duration T_{d} of an OFDM symbol based on the SCS, and then calculates a corresponding offset. A calculation formula is Offset=T_{d}−TA_{offset}−Tₚ. Tₚ is determined based on a current uplink timing advance. In a typical configuration, the uplink timing advance TA=2*Tₚ.

(b) In response to a scheduling indication or an explicit operating mode indication (for example, an uplink sending timing adjustment indication in the figure) being received, this value is used to cooperate with the parent node for performing space division reception. The operating mode indication is in either explicit or implicit manner, and is only for helping the IAB node determine a timing type that should be used. A specific manner is not limited. For example, the IAB node determines, based on the foregoing parameter configuration, that corresponding timing types are used in some slots, in other words, corresponding offsets are applied.

(c) A correspondence relationship between the offset and the SCS is shown, for example, in the following Table 1. The parent node is able to provide a correspondence relationship between each SCS and each offset in one piece of signaling. In other words, only a part of items in the following Table is included. The correspondence relationship reflected in actual signaling is also not limited to a form of the table. Whether another manner that reflects the correspondence relationship between the SCS and the offset is used is not limited in this embodiment. The SCS is not limited to the following SCSs, for example, the SCSs is alternatively 480 kHz and 960 KHz.

TABLE 1
Correspondence relationship between a
subcarrier spacing and an offset value.

| SCS | Timing offset relative to a TA |
|---|---|
| 15 kHz | Offset value 1 |
| 30 kHz | Offset value 2 |
| 60 kHz | Offset value 3 |
| 120 kHz | Offset value 4 |

(d) Alternatively, a correspondence relationship indicated by signaling is a correspondence relationship between an IAB-MT BWP index and an offset. The BWP index is replaced with an index of a downlink BWP, or is replaced with an index of an uplink BWP.

(e) For different BWPs that use a same SCS, a same offset value is used, and repeated notification is not used. Alternatively, for different carriers (carriers) or serving cells (serving cells) and/or BWPs that use a same SCS, a same offset value is used, and repeated notification is not used.

A process of calculating and determining the offset is also performed by a parent node of the IAB node. After determining the offset, the parent node indicates the IAB node by using signaling. A typical value range of the offset is T_{d}−T_{p,max}−TA_{offset}≤Offset≤T_{d}−TA_{offset}, or 2T_{d}−T_{p,max}−TA_{offset}≤Offset≤T_{d}−TA_{offset}. T_{p,max} represents a specified maximum broadcast delay, and a value range is related to a maximum transmission distance supported by IAB deployment. For example, at a broadcast distance of 2.5 km, T_{p,max}=8.333 . . . μs (microsecond).

In at least one embodiment, the IAB node or the donor node sends signaling to the child IAB node MT, where the signaling includes an offset value and an SCS or a BWP corresponding to the offset value.

(a) In response to the IAB-MT being further configured with a BWP using another SCS, in response to the IAB-MT performing transmission based on these parameters, the IAB autonomously performs conversion and determines, based on a relationship between symbol durations of different SCSs, an offset value corresponding to the SCS/BWP, and determines uplink sending timing in a space division multiplexing timing mode by adding a TA to the calculated offset.

For example, a symbol duration at 30 kHz is A. In this case, a symbol duration at 15 kHz is 2A, a symbol duration at 60 kHz is A/2, and a symbol duration at 120 kHz is A/4.

In response to an offset length configured for 30 kHz being X, and a 30 kHz subcarrier spacing is used in IAB-MT uplink, new uplink sending timing is directly calculated as TA+X. In response to the IAB being switched to a subcarrier spacing of 15 kHz, a new offset is set to X′=X+A. The foregoing conversion is an example. In another case, a conversion manner is not explicitly specified in a protocol. The IAB-MT performs conversion based on implementation, to determine an offset in another SCS.

(b) This implementation is further used in combination with the first implementation. For example, offsets corresponding to the 15 kHz subcarrier spacing and a 60 kHz subcarrier spacing are configured, and an offset corresponding to the 30 kHz subcarrier spacing is calculated based on an offset corresponding to the 15 kHz subcarrier spacing, an offset corresponding to a 120 kHz subcarrier spacing is calculated based on an offset corresponding to the 60 kHz subcarrier spacing. (Generally, 15 kHz and 30 kHz subcarrier spacings are used for low frequency bands, that is, FR1 frequency bands defined in a protocol. 60 kHz and 120 kHz subcarrier spacings are used for high frequency bands, for example, FR2 frequency bands defined in the protocol, where FR=frequency range. Different frequency ranges are to be configured with different offsets.)

In at least one embodiment, each time in response to the child IAB node MT changing an active uplink BWP and/or sending an SCS in an uplink manner, the IAB node or the donor node sends signaling to the child IAB node MT, to indicate a value or an index of an offset.

(a) The foregoing signaling is able to be sent only in response to the child IAB-MT being used to configure an additional sending timing offset to cooperate with the parent node to perform space division reception.

The foregoing describes the method in at least one embodiment, and the following describes an apparatus in at least one embodiment. The method and the apparatus are based on a same technical concept. The method and the apparatus have similar principles for resolving problems. Therefore, for implementations of the apparatus and the method, refer to each other. Details are not repeated herein.

In at least one embodiment, the apparatus is divided into functional modules based on the foregoing method examples. For example, the apparatus is divided into functional modules corresponding to functions, or two or more functions are integrated into one module. These modules are implemented in a form of hardware, or are implemented in a form of a software functional module. In at least one embodiment, module division is an example, and is merely a logical function division. In a specific implementation, another division manner is used.

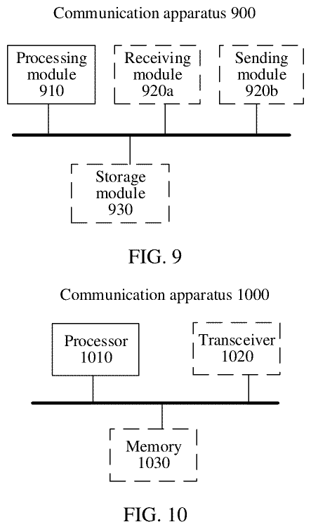

Based on the same technical concept as the foregoing method, FIG. 9 is a schematic diagram of a structure of a communication apparatus 900. The apparatus 900 includes a processing module 910, and optionally, further includes a receiving module 920a, a sending module 920b, and a storage module 930. The processing module 910 is separately connected to the storage module 930, the receiving module 920a, and the sending module 920b, and the storage module 930 is also connected to the receiving module 920a and the sending module 920b.

In an example, the receiving module 920a and the sending module 920b is alternatively integrated, and are defined as a transceiver module.

In an example, the apparatus 900 is a first node, or is a chip or a functional unit used in the first node. The apparatus 900 has any function of the first node in the foregoing method. For example, the apparatus 900 performs operations performed by the first node in the methods in FIG. 4, FIG. 5, FIG. 6, and FIG. 7.

The receiving module 920a performs a receiving action performed by the first node in the foregoing method embodiments.

The sending module 920b performs a sending action performed by the first node in the foregoing method embodiments.

The processing module 910 performs an action, other than the sending action and the receiving action, performed by the first node in the foregoing method embodiments.

In an example, the receiving module 920a is configured to receive a first message from a second node. The first message indicates a first ratio corresponding to a first downlink reference signal. The first ratio is a power ratio that is between data and a downlink reference signal and that is obtained after downlink transmission power adjustment is performed by a parent node.

The sending module 920b is configured to send a second message to the parent node. The second message includes a first measurement result. The first measurement result is determined based on the first ratio, and the first measurement result is determined based on the first downlink reference signal.

In an example, in response to the second node being the parent node, the first message further indicates a downlink transmission power adjustment amount used by the parent node and a corresponding first beam.

In an example, in response to the second node being a donor node, the first message includes downlink reference signal resource configuration information.

In an example, the receiving module 920a is further configured to receive a third message from the parent node. The third message indicates the downlink transmission power adjustment amount used by the parent node and the corresponding first beam.

In an example, the second message further includes a second measurement result. The second measurement result is determined based on a second ratio, and the second measurement result is determined based on the first downlink reference signal. The second ratio is a power ratio that is between data and a downlink reference signal and that is used before downlink transmission power adjustment is not performed by the parent node.

The processing module 910 is configured to: in response to a beam for measuring the first downlink reference signal being a beam associated with the first beam, determine to report the first measurement result corresponding to the beam for measuring the first downlink reference signal, or determine to report the first measurement result and the second measurement result corresponding to the beam for measuring the first downlink reference signal: or in response to the beam for measuring a downlink reference signal not being a beam associated with the first beam, determine to report the second measurement result corresponding to the beam for measuring the downlink reference signal.

The sending module 920b is further configured to send a fourth message to the parent node. The fourth message indicates a downlink transmission power adjustment amount desired by the apparatus and a second beam corresponding to the desired downlink transmission power adjustment amount.

In an example, the storage module 930 stores computer-executable instructions of the method performed by the first node, so that the processing module 910, the receiving module 920a, and the sending module 920b perform the method performed by the first node in the foregoing example.

For example, the storage module includes one or more memories. The memory is one or more devices or components in a circuit that are for storing a program or data. The storage module is a register, a cache, a RAM, or the like. The storage module is integrated with the processing module. The storage module is a ROM or another type of static storage device that stores static information and instructions. The storage module is independent of the processing module.

The transceiver module is an input/output interface, a pin, a circuit, or the like.

In an example, the apparatus 900 is a second node, or is a chip or a functional unit used in the second node. The apparatus 900 has any function of the second node in the foregoing method. For example, the apparatus 900 performs operations performed by the second node in the methods in FIG. 4, FIG. 5, FIG. 6, and FIG. 7.

The receiving module 920a performs a receiving action performed by the second node in the foregoing method embodiments.

The sending module 920b performs a sending action performed by the second node in the foregoing method embodiments.

The processing module 910 performs an action, other than the sending action and the receiving action, performed by the second node in the foregoing method embodiments.

In an example, the processing module 910 is configured to generate a first message.

In an example, the sending module 920b is configured to send the first message to a first node. The first message indicates a first ratio corresponding to a first downlink reference signal. The first ratio is a power ratio that is between data to a downlink reference signal and that is obtained after downlink transmission power adjustment is performed by the second node.

The receiving module 920a is configured to receive a second message from the first node. The second message includes a first measurement result. The first measurement result is determined based on the first ratio, and the first measurement result is determined based on the first downlink reference signal.

In an example, in response to the second node being the parent node, the first message further indicates a downlink transmission power adjustment amount used by the second node and a corresponding first beam.

In an example, in response to the second node being a donor node, the first message includes downlink reference signal resource configuration information.

In an example, the sending module 920b is configured to send a third message to the first node. The third message indicates the downlink transmission power adjustment amount used by the second node and the corresponding first beam.

In an example, the second message further includes a second measurement result. The second measurement result is determined based on a second ratio, and the second measurement result is determined based on the first downlink reference signal. The second ratio is a power ratio that is between data and a downlink reference signal and that is used before downlink transmission power adjustment is not performed by the second node.

The receiving module 920a is configured to receive a fourth message from the first node. The fourth message indicates a downlink transmission power adjustment amount desired by the first node and a second beam corresponding to the desired downlink transmission power adjustment amount.

In an example, the storage module 930 stores computer-executable instructions of the method performed by the second node, so that the processing module 910, the receiving module 920a, and the sending module 920b perform the method performed by the second node in the foregoing example.

For example, the storage module includes one or more memories. The memory is one or more devices or components in a circuit that are for storing a program or data. The storage module is a register, a cache, a RAM, or the like. The storage module is integrated with the processing module. The storage module is a ROM or another type of static storage device that stores static information and instructions. The storage module is independent of the processing module.

The transceiver module is an input/output interface, a pin, a circuit, or the like.

As a product form, the apparatus is implemented using a general bus architecture.

FIG. 10 is a schematic block diagram of a communication apparatus 1000.

The apparatus 1000 includes a processor 1010, and optionally, further includes a transceiver 1020 and a memory 1030. The transceiver 1020 is configured to receive a program or instructions and transmit the program or the instructions to the processor 1010. Alternatively, the transceiver 1020 is configured to perform communication interaction between the apparatus 1000 and another communication device, for example, exchange control signaling and/or service data. The transceiver 1020 is a code and/or data read/write transceiver, or the transceiver 1020 is a signal transmission transceiver between the processor and the transceiver. The processor 1010 and the memory 1030 are electrically coupled.

In an example, the apparatus 1000 is a first node, or is a chip used in the first node. The apparatus has any function of the first node in the foregoing method. For example, the apparatus 1000 performs operations performed by the first node in the methods in FIG. 4, FIG. 5, FIG. 6, and FIG. 7. For example, the memory 1030 is configured to store a computer program. The processor 1010 is configured to invoke the computer program or instructions stored in the memory 1030, to perform the method performed by the first node in the foregoing example, or perform, by using the transceiver 1020, the method performed by the first node in the foregoing example.

In an example, the apparatus 1000 is a second node, or is a chip used in the second node. The apparatus has any function of the second node in the foregoing method. For example, the apparatus 1000 performs operations performed by the second node in the methods in FIG. 4, FIG. 5, FIG. 6, and FIG. 7. For example, the memory 1030 is configured to store a computer program. The processor 1010 is configured to invoke the computer program or instructions stored in the memory 1030, to perform the method performed by the second node in the foregoing example, or perform, by using the transceiver 1020, the method performed by the second node in the foregoing example.

The processing module 910 in FIG. 9 is implemented by using the processor 1010.

The receiving module 920a and the sending module 920b in FIG. 9 is implemented by using the transceiver 1020. Alternatively, the transceiver 1020 includes a receiver and a transmitter. The receiver performs functions of the receiving module, and the transmitter performs functions of the sending module.

The storage module 930 in FIG. 9 is implemented by using the memory 1030.

As a product form, the apparatus is implemented by a general-purpose processor (the general-purpose processor is also referred to as a chip or a chip system).

In at least one embodiment, the general-purpose processor implementing the apparatus used in the first node or the apparatus used in the second node includes a processing circuit (the processing circuit is also referred to as a processor), and optionally a storage medium (the storage medium is also referred to as a memory) and an input/output interface for internal connection to and communication with the processing circuit. The storage medium is configured to store instructions executed by the processing circuit, to perform the method performed by the first node or the second node in the foregoing examples.

The processing module 910 in FIG. 9 is implemented by using the processing circuit.

The receiving module 920a and the sending module 920b in FIG. 9 is implemented by using the input/output interface. Alternatively, the input/output interface includes an input interface and an output interface. The input interface performs a function of the receiving module, and the output interface performs a function of the sending module.

The storage module 930 in FIG. 9 is implemented by using a storage medium.

As a product form, the apparatus in at least one embodiment is further implemented by using one or more FPGAs (field-programmable gate arrays), a PLD (programmable logic device), a controller, a state machine, a gate logic, a discrete hardware component, any other proper circuit, or any combination of circuits that performs various functions described in at least one embodiment.

At least one embodiment further provides a computer-readable storage medium that stores a computer program. In response to the computer program being executed by a computer, the computer is enabled to perform the foregoing communication methods. In other words, the computer program includes instructions for implementing the foregoing communication methods.

At least one embodiment further provides a computer program product. The computer program product includes computer program code. In response to the computer program code being run on a computer, the computer is enabled to perform the foregoing communication methods.

At least one embodiment further provides a communication system. The communication system includes a first node and a second node that perform the foregoing communication methods.

In addition, the processor mentioned in at least one embodiment is a central processing unit (CPU) or a baseband processor. The baseband processor and the CPU are integrated or separated, or is a network processor (NP) or a combination of a CPU and an NP. The processor further includes a hardware chip or another general-purpose processor. The hardware chip is an application-specific integrated circuit (ASIC), a programmable logic device (PLD), or a combination thereof. The PLD is a complex programmable logic device (CPLD), a field programmable gate array (FPGA), a generic array logic (GAL) and another programmable logic device, a discrete gate or a transistor logic device, a discrete hardware component, or the like, or any combination thereof. The general-purpose processor is a microprocessor, or the processor is any conventional processor or the like.

The memory mentioned in at least one embodiment is a volatile memory or a nonvolatile memory, or includes both a volatile memory and a nonvolatile memory. The nonvolatile memory is a read-only memory (ROM), a programmable read-only memory (PROM), an erasable programmable read-only memory (EPROM), an electrically erasable programmable read-only memory (EEPROM), or a flash memory. The volatile memory is a random access memory (RAM), serving as an external cache. Through example but not limitative descriptions, many forms of RAMs is used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). The memory described in at least one embodiment aims to include but is not limited to these memories and any memory of another proper type.

The transceiver mentioned in at least one embodiment includes a separate transmitter and/or a separate receiver, or the transmitter and the receiver are integrated. The transceiver operates based on instructions of a corresponding processor. Optionally, the transmitter corresponds to a transmitter machine in a physical device, and the receiver corresponds to a receiver machine in the physical device.

A person of ordinary skill in the art is aware that, in combination with the examples described in at least one embodiment, method operations and units is implemented by electronic hardware, computer software, or a combination thereof. To clearly describe interchangeability between the hardware and the software, the foregoing has generally described operations and compositions of each embodiment based on functions. Whether the functions are performed by hardware or software depends on particular applications and design constraint conditions of the technical solutions. A person of ordinary skill in the art is able to use different methods to implement the described functions for each particular application, but the implementation is not considered to go beyond the scope of embodiments described herein.

In at least one embodiment, the disclosed system, apparatus, and method is implemented in another manner. For example, the described apparatus embodiment is merely an example. For example, division into the units is merely logical function division and is other division during actual implementation. For example, a plurality of units or components is combined or integrated into another system, or some features are ignored or not performed. In addition, the displayed or discussed mutual couplings or direct couplings or communication connections is implemented through some interfaces, indirect couplings or communication connections between the apparatuses or units, or electrical connections, mechanical connections, or connections in another form.

The units described as separate parts is or is not physically separate, and parts displayed as units is or is not physical units, is located in one position, or is distributed on a plurality of network units. A part or all of the units is selected based on an actual usage to achieve objectives of the solutions of at least one embodiment.

In addition, functional units in at least one embodiment are integrated into one processing unit, each of the units exists alone physically, or two or more units are integrated into one unit. The integrated unit is implemented in a form of hardware, or is implemented in a form of a software functional unit.

In response to the integrated unit being implemented in the form of the software functional unit and sold or used as an independent product, the integrated unit is stored in a computer-readable storage medium. Based on such an understanding, the technical solutions in at least one embodiment essentially, or a part contributing to the conventional technology, or all or a part of the technical solutions is represented in a form of a software product. The computer software product is stored in a storage medium and includes several instructions for instructing a computer device (which is a personal computer, a server, a network device, or the like) to perform all or a part of the operations of the methods described in at least one embodiment. The foregoing storage medium includes: any medium that stores program code, such as a USB flash drive, a removable hard disk, a read-only memory (ROM), a random access memory (RAM), a magnetic disk, or an optical disc.

A term “and/or” in at least one embodiment describes an association relationship between associated objects and represents that three relationships exists. For example, A and/or B represents the following three cases: Only A exists, both A and B exist, and only B exists. A character “/” generally indicates an “or” relationship between the associated objects. “A plurality of” in at least one embodiment means two or more than two. In addition, in description of at least one embodiment, terms such as “first” and “second” are merely for distinguishing and description, but should not be understood as indicating or implying relative importance, or should not be understood as indicating or implying a sequence.

Although exemplary embodiments have been described, a person skilled in the art is able to make changes and modifications to these embodiments once the person learns a basic inventive concept. Therefore, the following claims are intended to be construed as to cover the preferred embodiments and all changes and modifications falling within the scope of at least one embodiment.

1. A communication method, comprising:
receiving a first message from a second node, wherein the first message is usable to indicate a first ratio corresponding to a first downlink reference signal, the first ratio is a power ratio that is between data and a downlink reference signal and that is obtained after downlink transmission power adjustment performed by a parent node, and the first ratio is usable to indicate a downlink transmission power adjustment amount used by the second node; and
sending a second message to the parent node, wherein the second message includes a first measurement result, the first measurement result is determined based on the first ratio, and the first measurement result is determined based on the first downlink reference signal.

2. The method according to claim 1, wherein the receiving the first message from the second node includes receiving the first message from the parent node, the first message further is usable to indicate a first beam corresponding to the downlink transmission power adjustment amount used by the parent node.

3. The method according to claim 2, wherein the receiving the first message incudes receiving the first message usable to indicate the first beam by using one or more of the following:
a resource identifier of the first downlink reference signal, an identifier of the first beam, or a transmission configuration indicator (TCI) state identifier corresponding to the first beam.

4. The method according to claim 2, further comprising:
in response to a beam for measuring the first downlink reference signal being a beam associated with the first beam, determining to report the first measurement result corresponding to the beam for measuring the first downlink reference signal.

5. The method according to claim 1, wherein before the receiving the first message from the second node, the method further comprises:
sending a third message to the parent node, wherein the third message is usable to indicate a downlink transmission power adjustment amount desired by the first node, and the third message is further usable to indicate a second beam or a second downlink reference signal corresponding to the desired downlink transmission power adjustment amount.

6. The method according to claim 5, wherein sending the third message usable to indicate the second beam includes sending one or more of the following:
a resource identifier of the second downlink reference signal, an identifier of the second beam, or a TCI state identifier corresponding to the second beam.

7. A communication apparatus, comprising:
at least one processor configured with processor-executable instructions to perform operations including:
receiving a first message from a second node, wherein the first message is usable to indicate a first ratio corresponding to a first downlink reference signal, the first ratio is a power ratio that is between data and a downlink reference signal and that is obtained after downlink transmission power adjustment performed by a parent node, and the first ratio is usable to indicate a downlink transmission power adjustment amount used by the second node; and
sending a second message to the parent node, wherein the second message includes a first measurement result, the first measurement result is determined based on the first ratio, and the first measurement result is determined based on the first downlink reference signal.

8. The communication apparatus according to claim 7, wherein in response to the second node being the parent node, the first message is further usable to indicate a first beam corresponding to the downlink transmission power adjustment amount usable by the parent node.

9. The communication apparatus according to claim 8, wherein the first message is usable to indicate the first beam by using one or more of the following:
a resource identifier of the first downlink reference signal, an identifier of the first beam, or a transmission configuration indicator (TCI) state identifier corresponding to the first beam.

10. The communication apparatus according to claim 8, further comprising:
in response to a beam for measuring the first downlink reference signal being a beam associated with the first beam, determining to report the first measurement result corresponding to the beam for measuring the first downlink reference signal.

11. The communication apparatus according to claim 7, wherein the at least one processor is further configured with processor-executable instructions to perform operations including:
sending a third message to the parent node, wherein the third message is usable to indicate a downlink transmission power adjustment amount desired by a first node, and the third message is further usable to indicate a second beam or a second downlink reference signal corresponding to the desired downlink transmission power adjustment amount.

12. The communication apparatus according to claim 11, wherein the third message is usable to indicate the second beam by using one or more of the following:
a resource identifier of the second downlink reference signal, an identifier of the second beam, or a TCI state identifier corresponding to the second beam.

13. A non-transitory computer-readable storage medium storing computer instructions, that when executed by at least one processor, cause the at least one processor to perform operations including:
receiving a first message from a second node, wherein the first message is usable to indicate a first ratio corresponding to a first downlink reference signal, the first ratio is a power ratio that is between data and a downlink reference signal and that is obtained after downlink transmission power adjustment performed by a parent node, and the first ratio is usable to indicate a downlink transmission power adjustment amount used by the second node; and
sending a second message to the parent node, wherein the second message includes a first measurement result, the first measurement result is determined based on the first ratio, and the first measurement result is determined based on the first downlink reference signal.

14. The non-transitory computer-readable storage medium according to claim 13, wherein in response to the second node is being the parent node, the first message is further usable to indicate a first beam corresponding to the downlink transmission power adjustment amount usable by the parent node.

15. The non-transitory computer-readable storage medium according to claim 14, wherein the first message is usable to indicate the first beam by using one or more of the following:
a resource identifier of the first downlink reference signal, an identifier of the first beam, or a transmission configuration indicator (TCI) state identifier corresponding to the first beam.

16. The non-transitory computer-readable storage medium according to claim 14, further comprising:
in response to a beam for measuring the first downlink reference signal being a beam associated with the first beam, determining to report the first measurement result corresponding to the beam for measuring the first downlink reference signal.

17. The non-transitory computer-readable storage medium according to claim 13, wherein the computer instructions, when executed by at least one processor, further cause the at least one processor to perform operations including:
sending a third message to the parent node, wherein the third message is usable to indicate a downlink transmission power adjustment amount desired by a first node, and the third message is further usable to indicate a second beam or a second downlink reference signal corresponding to the desired downlink transmission power adjustment amount.

18. The non-transitory computer-readable storage medium according to claim 17, wherein the third message is usable to indicate the second beam by using one or more of the following:
a resource identifier of the second downlink reference signal, an identifier of the second beam, or a TCI state identifier corresponding to the second beam.
